(19) United States
(12) Patent Application Publication
(10) Pub. No.: US 2017/0111364 A1
(43) Pub. Date: Apr. 20, 2017

(54) DETERMINING FRAUDULENT USER ACCOUNTS USING CONTACT INFORMATION

(71) Applicant: Uber Technologies, Inc., San Francisco, CA (US)

(72) Inventor: Sachin Rawat, San Francisco, CA (US)

(21) Appl. No.: 14/883,436

(22) Filed: Oct. 14, 2015

(51) Int. Cl. H04L 29/06

(52) U.S. Cl. CPC H04L 63/102; H04L 63/1433

(57) ABSTRACT

A system can receive sets of contact information from a plurality of devices. Each set of contact information can be associated with a user account of a plurality of user accounts. The system can determine connection information for the plurality of user accounts based on the received sets of contact information. The system can identify a first subset of user accounts is identified as being trusted and a second subset of user accounts is identified as being fraudulent, and subsequently, identify one or more user accounts that are not in the first subset and not in the second subset as being trusted or fraudulent based, at least in part, on the connection information for the plurality of user accounts, and the identified first subset and the identified second subset.

### BACKGROUND

The prevalence of e-commerce has resulted in many companies and entities providing network services to allow users to purchase goods or services through use of their computing devices. In some instances, however, because e-commerce transactions are processed by systems without requiring the actual physical presence of users (e.g., there is no face-to-face contact between a purchase of a good and the provider of the network service that processes payments), some users have learned to abuse the network services for the primary purpose of receiving financial gain inappropriately or unlawfully.

### BRIEF DESCRIPTION OF THE DRAWINGS

FIG. 1 illustrates an example system to determine fraudulent user accounts, according to an embodiment.

FIGS. 2A through 2C illustrate example methods for determining fraudulent user accounts, in some embodiments.

FIGS. 3A through 3D illustrate example diagrams of connected user accounts, under an embodiment.

FIG. 4 is a block diagram that illustrates a computer system upon which embodiments described herein may be implemented.

FIG. 5 is a block diagram that illustrates a mobile computing device upon which embodiments described herein may be implemented.

### DETAILED DESCRIPTION

Examples described herein provide a system to determine fraudulent user accounts using sets of contact information that are associated with the user accounts. By identifying fraudulent user accounts, a network service can perform remedial actions to prevent (or deter) inappropriate or unlawful behavior by individuals using such user accounts to abuse the network service.

As referred to herein, a user account of a network service can be created by or created for a user for purposes of enabling the user to request a service (e.g., a requester or a rider) or provide a service (e.g., a service provider or a driver). Typically, in examples described herein, a user account can be associated with a specific phone number associated with a mobile computing device. In some instances, a fraudulent user may create a user account and use the user account in a manner that defrauds the entity that provides the network service. A fraudulent user may defraud the service arrangement system by ordering and/or paying for goods or services using falsified information (e.g., a fake name, a fake address, etc.) or misappropriated payment methods (e.g., stolen credit cards, credit card numbers, bank account information, etc.), by improperly taking advantage of financial promotions for the user's financial gain (e.g., discounts for goods or services), or by using the network service to perform illicit actions. As described herein, a user account associated with or used by a fraudulent user is referred to as a “fraudulent user account.”

In other examples, in the context of transport services, fraudulent users can abuse the network service's rider incentives and/or driver incentives, in which first time riders can receive a free transport service or a discounted fee, or drivers who refer first time drivers can receive a large referral fee, respectively. Still further, in one example, a fraudulent user can operate a device with multiple burner (or fake) phone numbers and create multiple fraudulent rider accounts (e.g., user accounts associated with riders or requesters of transport services) using those burner phone numbers to continue to receive first time rider promotions. In another example, a fraudulent user can create a driver account (e.g., a user account associated with a driver) to provide fake transport services. The fraudulent user can operate a hacking application on the user's device using the driver account to spoof or deceive the network service into determining that a transport service has been provided by the fraudulent user. Such a hacking application can provide fake data and fake location data points to the network service to falsify a route traveled in order to receive the financial benefit of the transport service.

According to some examples, a system, such as a service arrangement system that implements the network service, can determine reputation scores for user accounts based on data from the contact list of participating users. The system can receive, over one or more networks, sets of contact information associated with a plurality of user accounts, where each set of contact information is associated with a user account (and subsequently, a user of the user account). For example, a first user operating a first device can have information about a set of contacts (e.g., friends, family, acquaintances, etc.) in a contacts application or a phone application stored in a memory of the first device. Using the received sets of contact information, the system can determine connection information for the plurality of user accounts. In other words, for each user account, the system can determine which other user accounts of the plurality of user accounts that user account has a connection with, if any. The system can build a social graph, for example, that indicates how the user accounts are connected to other user accounts (e.g., the directed edges of the social graph can indicate which users know other users based on whose contact information is included in the users' list of contacts).

In one example, the system can identify a first subset of user accounts as being trusted and a second subset of user accounts as being fraudulent. The system can identify the first subset and the second subset based on fraud scores that are previously determined by the system. Such fraud scores, in an example, can be based, at least in part, on historical data associated with a user's previous use of the network service. The system can subsequently perform a contagion process, in which other user accounts that are not in the first subset and not in the second subset are identified as being trusted or fraudulent based, at least in part, on the connection information for the plurality of user accounts and the identified first subset and second subset. For example, the contagion process results in additional user accounts to be identified as being trusted or fraudulent (or as another label) based on which user accounts those user accounts are connected to. According to one example, once the user accounts are identified as trusted or fraudulent, the system can mark or label the user accounts accordingly, and perform remedial actions in connection with user accounts that are marked as fraudulent.

In some examples, the system can compute a reputation score for each user account of the plurality of user accounts based, at least in part, on which other user accounts that user account has a connection with, and whether the other user accounts are identified as being trusted or fraudulent. The reputation score can correspond to a set of values, including a first value corresponding to a trust score and a second value corresponding to a fraud score. For each user account, the system can assign a classification based on the set of values of the reputation score. In such examples, the system can perform remedial actions when users using user accounts that are assigned fraudulent classifications access the network service and/or attempt to request or provide a service.

Among other benefits and technical effect, examples described herein provide a programmatic mechanism to detect fake or fraudulent user accounts of a network service to prevent inappropriate financial gain by fraudulent users. Examples contemplate that hundreds of thousands of users can use the network service for both fraudulent and legitimate purposes (e.g., proper use of requesting and receiving services, and paying and receiving payments for such service, respectively). As such, detecting fraudulent user accounts in hundreds of thousands (or millions) of user accounts through manual processes is unreliable and difficult, if not impossible, and thus, requires computer-implemented processes, such as described in examples herein.

Some examples utilize social connections between users in order to determine fraudulent accounts and/or activity. In using social connections, variations also implement programmatic processes to ensure information items which link individuals together (e.g., contact records, friends list on social network, people whom have received information or shared resources with one another, or shared experiences, etc.) are aggregated in a manner that maintains a desired level of privacy, specifically one that meets standards required by law, terms of service, or desired best practice by the network operator. In many cases, it is desired that the information items which are obtained from users for purpose of determining social connections are not accessible to humans other than those whom a given user has explicitly authorized. Some examples recognize that while a fraudulent user can attempt to spoof or deceive the network service by adding the contact information for non-fraudulent users in the fraudulent user's set of contact information, it would be significantly more difficult and unlikely for the fraudulent user to cause a non-fraudulent user to add the fraudulent user's contact information in the non-fraudulent user's set of contact information.

In order to determine such fraudulent occurrences, some examples utilize a social graph which plots connections amongst known users, even those users whom have genuine accounts and/or whom perform legitimate account activities. The aggregation of contact information to develop the social graph may thus utilize information from many users and the privacy standards/preferences of the users may differ. Accordingly, in many cases, the social graph may need to be developed under the strictest privacy guard, so as to satisfy the highest threshold of each user account or preference in the social graph.

Some examples further recognize that a contagion operation implemented on a social graph can readily detect when contact information is shared amongst users who are determined (or suspected as being fraudulent), as well as amongst users who are believed to be genuine. However, the contagion operation would need to be of a particular size (e.g., expansive, depth, number of connections) for the contagion operation to be sufficiently reliable for the intended user. Among other benefits, an example system can prevent spoofing by fraudulent users as a result of the manner in which the system uses data associated with the different connections to determine fraudulent user accounts.

Examples also include a system and method for validating an account activity based on contagion operations and graph proximity. In some examples, an account activity of a user can be validated (or conversely assumed fraudulent) based on a social graph that is aggregated from multiple sources. The social graph is formulated at least in part so that connections for anyone user extend to individuals whom the user would have no knowledge of as being part of a social graph that validates the user account or activity. By precluding an ability of a user to have knowledge of the social graph used to validate the particular account or activity of the user, the occasional fraudulent user has far less ability to escape detection.

Moreover, the social connections between persons of a social graph can be based on information items such as name, phone number, email address, or other personal identifiable information. While the information items for a social graph can be obtained from a user, the information which the user provides about social contacts can be augmented and updated from other sources (e.g., with information from other users) for those same contacts. Thus, some implementation of the social graph can involve aggregation of information items for records associated with individual persons, as well as by grouping and connecting persons using the information items. Among other benefits, some examples enable person-specific information to be aggregated from multiple sources for purpose of implementing a social graph, in a manner in which no one person can view or comprehend, for purpose of validating an activity or account of a given user.

Accordingly, while such personal information can be culled and used to build connections of the social graph, the information items can also be made indecipherable to humans through, for example, computational processes such as implemented through hash functions. In some implementations, persons are represented on the social graph by data sets, which can include, for example, different forms of personal identifiable information (e.g., phone number, email address, moniker, etc.). By making such information items indecipherable, the social graph can protect information items from unauthorized access and use. More generally, the information can be culled from network services with rules or provisions which permit computer-implemented aggregation and use of such information. Generally, terms of service provisions which deny human access to the user's information items while at the same time permitting programmatic access, are more acceptable to users, and thus promote willingness by users to have various aspects of the personal information accessed and used for constructing a protected form of a social graph. As a result, the social graph, and computational processes for maintaining and using the social graph, can be made more efficient because more data sets (e.g., more kinds of personal identifiable information, user-specific information or class-specific information) can be used to build a richer (e.g., more connections) and more comprehensive social graph.

Accordingly, some examples implement specialized processes and devices to aggregate user-specific or class-specific information for purpose of making contagion determinations. Such devices can include, for example, geo-aware devices which uses sensors (e.g., GPS, wireless signal determination, etc.) to determine, store and/or communicate geographic information in a protected, non-human-decipherable manner. In some variations, such devices can also store contact information and/or other records, as well as account information and/or credentials where information can be obtained. Moreover, some examples provide that such information can be culled and analyzed by a network service in a manner that ensures complete inaccessibility to humans, even those who may have access to the protected data by virtue of being an administrator for the network service.

As used herein, “user-specific information” means information that is likely to be accurate for one user in a group of users of a given sample size (e.g., more than 10 (e.g., first name, email address domain), (e.g., four or seven digits of a phone number) or truly unique (e.g., ten digit phone number). “Class-specific information,” refers to information for a defined class of persons, such as age group, gender, alma mater, etc.

As used herein, a client device, a rider device, a driver device, a computing device, and/or a mobile computing device refer to user devices corresponding to desktop computers, cellular devices or smartphones, personal digital assistants (PDAs), laptop computers, tablet devices, etc., that can provide network connectivity and processing resources for communicating with the system over one or more networks. Rider devices and driver devices can each operate a designated service application (e.g., a rider client application and a driver client application, respectively) that is configured to communicate with an on-demand service arrangement system using secure channels. A driver device can also correspond to a computing device that is installed in or incorporated with a vehicle, such as part of the vehicle's on-board computing system.

According to some examples, the user devices, whether operated by rider or driver, utilize programmatic resources that originate from the network service in order to operate as part of the network service. For example, each of the rider and driver device can execute an application (or “app”) from the network service in order to control information that is communicated to the network service when the application is executing on the network service. In particular, the applications can execute to ensure the data communicated from the respective mobile computing devices is not interfered or tampered with by individuals who operate the corresponding devices. This ensures that the network service can obtain information which accurately reflects a given condition or event. Moreover, the rider or driver applications can execute, for example, hashing functions on data stored on the rider or driver device for purpose of communicating such data to the network service, and/or formulating a social graph that is relevant to a corresponding user.

Still further, while examples herein describe the system in connection with transport services, in other examples, the network service can provide a variety of other services, such as a food truck service, a delivery service, an entertainment service, etc., to be arranged between requesters, in general, and service providers. In other examples, the system can be implemented by any entity that provides goods or services for purchase through the use of computing devices and network(s).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

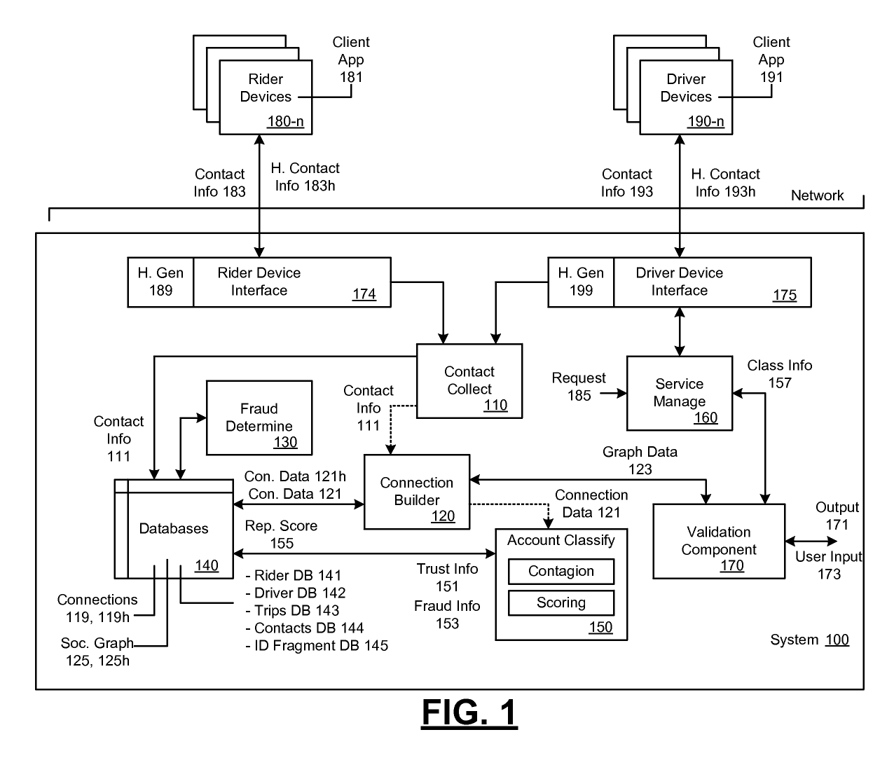

FIG. 1 illustrates an example system to determine fraudulent user accounts, according to an embodiment. In the example of FIG. 1, a service arrangement system 100 includes a contact collect 110, an connection builder 120, a fraud determine 130, an account classify 150, a service manage 160, a validation component 170, a rider device interface 174, a driver device interface 175, and a plurality of databases 140, including a rider database 141, a driver database 142, a trips database 143, a contacts database 144, and/or an identifier (ID) fragment database 145. The databases 140 can be stored in one or more memory resources of or accessible by the system 100. A plurality of rider devices 180 (e.g., users who operate requester devices on which a rider application or programmatic resource of the arrangement system 100 is executed) and a plurality of driver devices 190 (e.g., service provider devices, including individuals who operate driver devices on which a driver application or programmatic resource of the arrangement system 100 is executed) can communicate with the system 100. The rider and driver devices 180, 190 can communicate over one or more networks using, for example, respective designated service client applications 181, 191 that are configured to communicate with the system 100. As referred to herein, a user device can correspond to either a rider device or a driver device, and a user can correspond to either a rider or a driver (e.g., as both are considered users of the network service). The components of the system 100 can combine to perform fraud detection processes and/or to arrange a service for a requesting user. Logic can be implemented with various applications (e.g., software) and/or with hardware of a computer system that implements the system 100.

Depending on implementation, one or more components of the system 100 can be implemented on network side resources, such as on one or more servers or computing systems. The system 100 can also be implemented through other computer systems in alternative architectures (e.g., peer-to-peer networks, etc.). As an addition or an alternative, some or all of the components of the system 100 can be implemented on user devices, such as through applications that operate on the rider devices 180 and/or the driver devices 190. For example, a rider service application 181 and/or a driver service application 191 can execute to perform one or more of the processes described by the various components of the system 100. The system 100 can communicate over a network, via a network interface (e.g., wirelessly or using a wireline), to communicate with the one or more rider devices 180 and the one or more driver devices 190.

The system 100 can communicate, over one or more networks, with rider devices 180 and driver devices 190 using a rider device interface 174 and a driver device interface 175, respectively. The device interfaces 174, 175 can each manage communications between the system 100 and the respective computing devices 180, 190. The rider devices 180 and the driver devices 190 can individually operate rider service applications 181 and driver service applications 191, respectively, that can interface with the device interfaces 174, 175 to communicate with the system 100. According to some examples, these applications can include or use an application programming interface (API), such as an externally facing API, to communicate data with the device interfaces 174, 175. The externally facing API can provide access to the system 100 via secure access channels over the network through any number of methods, such as web-based forms, programmatic access via RESTful APIs, Simple Object Access Protocol (SOAP), remote procedure call (RPC), scripting access, etc.

In addition, while the system 100 is described as a service arrangement system that implements a network service in examples described herein, in other examples, the system 100 can correspond to a fraud detection system that is a part of or communicates with the service arrangement system. For example, one or more components of the system 100 can be implemented by the fraud detection system, such as the contact collect 110, the connection builder 120, the fraud determine 130, and the account classify 150. The service arrangement system can implement the service manage 160 to receive requests for services and match service providers to provide those services for the requesters. Still further, the fraud detection system and/or the service arrangement system can also each access one or more of the databases 140.

According to an example, the system 100 can enable users of rider devices 180 to request services, such as transport services, through use of the service applications 181, and can enable users of driver devices 190 to receive invitations to perform services through use of the service applications 191. The system 100 can typically receive a request for transport service from a rider device 180, arrange the transport service (also referred to herein as a “trip”) to be provided by a driver, and send an invitation for the driver to accept and subsequently provide the transport service. For example, the service manage 160 can receive the request and select a driver based on information from the request, such as a pickup location, a vehicle type, and/or a destination location. The service manage 160 can access driver information from the driver database 142 (e.g., such as the drivers' current locations and statuses) to determine a pool of candidate drivers based on the information from the request and select the driver for the rider from the pool of candidate drivers.

When the trip is arranged for the rider, the service manage 160 can monitor the status of the transport service (e.g., by communicating with the driver device 190 of the selected driver through use of the driver service application 191). For example, the driver application 191 can communicate with a global positioning system (GPS) receiver or component of the driver device 190 and can periodically transmit location data corresponding to the current location of the driver device, determined via the GPS receiver, to the driver device interface 175. During and/or after completion of the trip, the service manage 160 can store information about the trip (e.g., referred to herein as trip information) as a trip record or entry in the trips database 143, such as the rider's ID, the rider device ID, the driver's ID, the driver device ID, the route taken, the time for pickup and the time for drop off, and/or the price for the trip, or other trip information. The service manage 160 can store trip entries in the trips database 143 as trips are requested and/or completed, and can associate trip entries with corresponding riders and drivers. In this manner, the trips database 143 can store historical information about transport services that have been requested by and/or completed by users. Such historical information about previously received or provided transport services can be associated with the respective users' accounts or profiles.

For example, each user of the system 100 can have an associated user account stored in a database 140. For example, a rider can have an associated rider user account stored in the rider database 141 and a driver can have an associated driver user account stored in the driver database 142. As described herein, the rider and driver databases 141, 143 can store hundreds of thousands of respective user accounts. According to one or more examples, each user account can include or be associated with various information items that are specific to the user or user class, including, for example, (i) the user's name, (ii) the user's contact information (e.g., phone number that is associated with the user's device, email address, home address or geographic region, etc.), (iii) the user's device information (e.g., mobile device ID, device type, etc.), (iv) the user's previous completed trips (e.g., corresponding to trip entries which are stored in the trips database 143), (v) a user rating, (vi) user documents (e.g., terms and conditions, background check information for drivers, signed contracts for drivers, etc.), (vii) payment information or billing information (e.g., credit card information or electronic banking account, etc.), (viii) a fraud score, and/or (ix) a reputation score.

The system 100 can store and maintain the user accounts in the respective rider database 141 and the driver database 142. While information of a user account can be provided and/or modified by the respective user in response to the user providing input via the rider device 180 or driver device 190 (e.g., such as the user's preferred email address or location, or the user's payment information), in some examples, the components of the system 100 can modify information in a user account with up-to-date information, such as when a trip is requested and/or completed for the user. For example, a rider's user rating may change based on the rating recently provided by the driver that just dropped off the rider. In another example, the fraud determine 130 can update the fraud score of a user account based on recently completed account activity (e.g., activity in connection with transport services).

In examples described herein, the system 100 can determine fraudulent user accounts based on contact information provided by users. The system 100 can provide riders and/or drivers with an option to agree to share the contact information of their contacts (e.g., friends, relatives, acquaintances, co-workers, etc.) with the system 100. For example, the system 100 can provide certain benefits (e.g., financial or social perks) to those users who opt in to share their contacts with the system 100. In one example, for users that have not yet opted in to share their contacts, the system 100 can cause the respective client applications 181, 191 to display a notification or a user interface (UI) panel that provides content explaining what it means to opt into this feature and/or what the benefits are. The notification or the UI Panel can include a selectable feature for users to opt in or agree to share their contacts.

Depending on implementation, if a user (e.g., a rider, in this example) provides input on the notification or the UI panel to opt in or agree to share the contact information of his or her contacts with the system 100, the rider client application 181 can communicate with the contacts application (or phone application) stored on the rider device 180 to retrieve the set of contact information from the contacts application. In another example, the rider client application 181 can retrieve the sets of contact information by accessing the appropriate memory addresses of the memory resource(s) of the rider device 180. Each rider client application 181 of a plurality of rider device 180 can transmit the set of contact information 183 to the system 100 via the rider device interface 174 for those riders that opt in to share their contacts. Similarly, each driver client application 191 of a plurality of driver devices 190 can transmit a respective set of contact information 193 to the system 100 via the driver device interface 175 for those drivers that opt in to share their contacts.

As an addition or variation, the sets of contact information 183, 193 can be retrieved from sources other than the contacts application or phone application of the various user devices, such as a social networking application or a messaging application. As an addition or an alternative, the system 100 can communicate with social networking systems over one or more networks to receive individual users' sets of contact information (e.g., a user can have an account with a social networking service and can be connected to friends or acquaintances). The system 100 can use the sets of contact information (e.g., one or more of a name, a user name, a phone number, an email address, etc.) from the social networking system(s) to determine the connections, make validation determinations, and/or compute scores, such as described with in more detail with some examples.

An individual user can have one or more contacts stored in the user's device, with each contact being stored as a contact record or entry of a particular application (e.g., contact application, messaging application, a phone application, etc.). Each contact record, in some examples, can include one or more information items, such as a name (e.g., a first name and/or a last name), and/or one or more communication identifiers (e.g., phone number, email address or messaging identifier). Accordingly, contact information includes information items which can be used by an individual operating a device to contact or establish communications with another individual operating another device. Such information items can include, for example, a phone number of an individual, an email address of the individual, and/or a user name of the individual (e.g., for a messaging service). In one example, for each rider of a plurality of riders and/or for each driver of a plurality of drivers, the contact collect 110 can receive sets of contact information 183 of that rider's contacts and/or sets of contact information 193 of that driver's contacts along with an identifier (or alternatively, the contact information) of that rider and/or driver. As an addition or an alternative, the contact collect 110 can receive other information along with the sets of contact information, such as names of the respective contacts, addresses, and/or other data. In one example, the contact collect 110 can also perform operations to verify each of the sets of contact information received from the users.

For each received set of contact information, the contact collect 110 can store the set of contact information of a respective user's set of contacts in association with that user's identifier or user account (represented as contact information 111) in the contacts database 144. Depending on implementation, the contact collect 110 can also provide the sets of contact information 111 to the connection builder 120. In one implementation, the connection builder 120 can use the sets of contact information 111 (e.g., received from the contact collect 110 or retrieved from the contacts database 144), as retrieved from respective user accounts of the system 100, to determine individual connections 119 between user accounts. The connection builder 120 can determine connections data 121, which defines connections 119 between individual users 121, for purpose of making validation determinations. The individual connections 119 amongst persons can be made when an information item of a contact record in the contact collection of one user matches an information item of another user. As an addition or alternative, the individual connections between users can be made when an information item of a contact record in the contact collection of one user matches an information item in the contact records of another user.

In some examples, the connections 119, as defined by the connection data 121, can be organized or structured into a social graph 125. The social graph can, for example, define users as nodes of a graph, with connections 119 linking the nodes. As mentioned with other examples, the linking can correspond to (i) the information item of one user being in a contact record of another user, or (ii) the information item of a contact of a user being the same as the information item of the contact of another user. With aggregation of contact records, the social graph can be expanded many nodes, and relationships between individuals in the social graph 125 can be defined in part by degrees (e.g., number of degrees which separate two individuals).

By way of example, ten riders may have agreed to share their contacts with the system 100. For each of the ten riders, the connection builder 120 can determine which of the other nine riders, if any, that rider has contact information for in that rider's list of contacts. In other words, the connection builder 120 can determine, for each user account of the rider, which other user account that user account has a connection with. The connection builder 120 can establish a one-way connection from a first user account to a second user account if the first user of the first user account had, in the first user's set of contacts, contact information associated with the second user account. Similarly, the connection builder 120 can establish another one-way connection from the second user account to the second user account if the second user of the second user account had, in the second user's set of contacts, contact information associated with the first user account. Accordingly, a single user account can have a one way-connection from (or a directed edge pointed to it by) multiple other user accounts, and/or can have multiple one-way connections to multiple other user accounts.

The information about how user accounts are connected to other user accounts can be stored as connection data 121 in a database 140, such as a connections database (not shown in FIG. 1 for simplicity). The connection data 121, for example, can be stored in a table(s) or list(s) indicating one-way connections (and/or mutual connections if two user accounts have one-way connections with each other) or can be stored as pointers or other data structures. Alternatively, the connection builder 120 can provide the connection data 121 to the account classify 150. Still further, in one example, the connection builder 120 can determine or generate, as an example of the social graph 125, a directed graph that establishes, for individual user accounts, directed edges or one-way connections from that user account to other user accounts. In such an example, the social graph 125 can be stored as a structured or organized set of connections 119 in the connections database 140. Relevant segments of the social graph 125 can also be provided to the account classify 150. Alternatively, the account classify 150 can retrieve the connections 119, the social graph 125, or the connection data 121 from the connections database 140 when performing one or more contagion operation(s), as well as for calculating the reputation scores for user accounts.

According to some examples, the account classify 150 can categorize, score, weight and determine other parameters or labels for user accounts and/or account activities. The parameters (e.g., reputation score 155) can serve as indicators as to whether a particular person (e.g., user, as represented in the social graph 125) is genuine or fraudulent. The account classify 150 can generate weights and/or scores (e.g., reputation scores 155, as described below) for association with (i) individual user accounts, (ii) one or more information items (e.g., contact identifier, communication identifier, etc.) of the user's personal contact information, separate from the association with the user, and/or (iii) with contact records or information items thereof of individual users. In one example, the account classify 150 can identify a first subset of user accounts of the plurality of user accounts as being trusted and/or a second subset of user accounts of the plurality of user accounts as being fraudulent. As used herein, a subset of user accounts can correspond to one or more user accounts. In some examples, the account classify 150 can determine the first subset of user accounts and the second subset of user accounts from trust information 151 and/or fraud information 153 associated with or stored with the plurality of user accounts.

As an addition or alternative, the association between trust information 151 and/or fraud information 153 can extend to specific information items that are associated with a particular account for which a classification or other indication (e.g., weight, score etc.) has been made. Thus, if a phone number associated with an account that is determined to be fraudulent is reused by a bad actor, the phone number itself can serve as a flag that the new account is also fraudulent.

In variations, the fraud determine 130 can use various types of alternative information associated with a user account when determining whether that user account is a fraudulent or fake user account. Such alternative types of information can be used in combination with connection data 121, or alternatively, in combination with a social graph that is formed from the connection data 121. The historical information can, for example, correspond to historical information about previous transport services (e.g., information about trips requested, received, and/or provided by that user). In some instances, such historical information can be informative as to how the corresponding user uses or has used the network service (e.g., the user's usage behavior). For example, Such information can indicate the user's propensities, such as when the user typically requests transport services (e.g., day, time of day, etc.), where the user travels to and/or from, what vehicle type(s) the user likes to travel in, how long the user typically travels (e.g., shorter trips, such as ten or fifteen minute trips, or longer trips, such as forty-five minutes or sixty minute trips, etc.), how the user typically pays for the trips, etc.

In some examples, for individual user account, the fraud determine 130 can use information about trips of the user from the trips database 143 and user information from the user account (e.g., stored in the rider database 141 or the driver database 142) to determine a fraud score for that user account (e.g., fraud information 153). The fraud score can be indicative of a level of fraud (or potential fraud), such as, for example, a score of zero to one hundred, where zero is trusted or non-fraudulent and one-hundred is fraudulent. The fraud determine 130 can determine the fraud score based on one or more rules or parameters specifying what factor(s) to use to compute the fraud score and/or what weights (e.g., such as a multiplier or percentage to apply to a factor) to apply to what factor(s) to compute the fraud score. Weights can cause one factor to influence the fraud score more heavily than another factor. A rule or parameter can also specify the threshold fraud score. Still further, in some examples, a rule or parameter can specify when or how often the fraud determine 130 is to determine or update the fraud score for individual user accounts (e.g., periodically every day or every week, or every time a trip is requested or completed for a user account, etc.). The rules or parameters can be configured by an administrative user of the system 100.

The factors that are used by the fraud determine 130 can correspond to information associated with a user account or other information derived from such information. For example, the factors used to determine the fraud score for a user account can include (i) a time when the user account was created (or a duration of time since the corresponding user signed up), (ii) the number of times the user added, deleted, or modified payment methods, (iii) the number of times a payment method was declined, (iv) the amount of money spent by the corresponding user (e.g., total amount spent, amount spent over the last specified duration of time, or amount spent within a specified duration), (v) the geographic location of the user or geographic regions where the user typically requests and/or receives transport services (e.g., the pickup and/or destination locations, whether the locations or addresses correspond to landmarks of interest, etc.), (vi) the geographic location of the user as compared to the billing address or geographic location corresponding to a payment method, (vii) whether the contact information of the user has been verified (e.g., the mobile phone number or email address), (viii) the lengths and/or prices of the transport services received (e.g., durations and/or distances of the trip), (ix) the number of times promotions are used by the corresponding user, (x) whether another user account exists that share the contact information as the account (e.g., same phone number or email address or home or billing address, etc.), (xi) whether a payment method was provided by the corresponding user using the image capture process, (xii) whether a payment method has been flagged as being a stolen or misappropriated payment method, and/or other information associated with the user account or trips requested by and/or provided for the corresponding user.

Based on the rules or parameters, for each user account, the fraud determine 130 can determine one or more of the factors associated with that user account, apply weight(s) to the one or more factors, and compute a fraud score. According to one example, the fraud determine 130 can then compare the fraud score to a default or threshold fraud score. If the fraud score for a user account is equal to or greater than the threshold fraud score (e.g., greater than fifty, from zero to one hundred), the fraud determine 130 can determine that the user account is a fraudulent user account, and mark or flag the user account (e.g., using a bit or multiple bits, etc.). As an addition or an alternative, the fraud determine 130 can determine user accounts that are determined to be trusted by comparing the fraud score to a second default or threshold fraud score. For example, if the fraud score for a user account is equal to or less than the second threshold fraud score (e.g., less than five, from zero to one hundred), the fraud determine 130 can determine that the user account is a trusted user account, and mark or flag the user account as such (e.g., as represented by the trusted information 151 in FIG. 1). In some examples, for other user accounts having fraud scores that are between the two threshold fraud scores, the fraud determine 130 may not mark those accounts as fraudulent or trusted, or alternatively, may mark those accounts as being indeterminate or unverified.

Referring back to the account classify 150, the account classify 150 can use the connections 119, the social graph 125 and/or the connection data 121 to determine relationships as between individual user accounts (or users) and other accounts or persons. The relationships can (i) identify connections 119 which are direct, (ii) determine directionality of the connection 119 based on connection data 121, and/or (iii) determine relationships that extend to two or more degrees using the connection data 121 and the social graph 125. The account classify 150 can also use the trust information 151 and/or the fraud information 153 to identify the first subset of user accounts as being trusted (e.g., initially trusted) and/or to identify the second subset of user accounts as being fraudulent (e.g., initially fraudulent), respectively. In some examples, the account classify 150 can label or mark the identified first and/or second subset of user accounts as being initially trusted and/or initially fraudulent, respectively, e.g., such as by using a labeling or marking scheme (e.g., textual string, binary, etc.).

According to an example, the account classify 150 can include a contagion component (e.g., a sub-component of the account classify 150) for performing one or more contagion processes or operations to identify user accounts as being trusted or fraudulent. The contagion component can identify one or more other user accounts that are not in the first and/or second subsets as being trusted or fraudulent (or as unknown or as colluding) based, at least in part, on the connections 119, the social graph 125 and/or the connection data 121 of the plurality of user accounts and the identified first subset of user accounts and/or the identified second subset of user accounts. For example, the contagion component can determine, from the connection data 121, which user account(s) each initially trusted user account is connected to (e.g., which user account(s) has a directed edge pointing from an initially trusted user account in the example of a directed graph), and can indicate or label such user account(s) accordingly. This can be considered a first-step or first-degree contagion operation, in which user accounts that are one step or one degree away from the initially trusted user account(s) are identified and/or labeled as being trusted. The contagion component can then look at those additionally identified trusted user accounts and then determine, from the connection data 121, which user account(s) each of those trusted additionally identified user accounts is connected to (e.g., points to), and again label such user account(s) as such, resulting in a second-step or second-degree contagion operation, and so forth. Depending on implementation, the contagion component can perform multiple contagion operations (e.g., or in other words, can perform a multi-step or multi-degree contagion operation) to identify one or more user accounts as being trusted or fraudulent. The number of steps or degrees of contagion operations can be configured by an administrative user of the system 100. In some implementations, the account classify 150 can execute the contagion operations to determine parametric indicators for individual accounts, such as reputations score 155, using factors (e.g., weights) such as (i) social graph proximity (as determined by degrees) to trusted accounts or untrusted accounts (or confirmed trusted or fraudulent), (ii) number of total connections 119 of the account (e.g., fraudulent accounts will have fewer connections, and/or (iii) number of connections to trusted or untrusted accounts.

The contagion component can also determine, connections 119, the social graph 125 and/or the connection data 121, which user account(s) each initially fraudulent user account is connected to, and which other user account(s) that user account(s) that is subsequently identified as being fraudulent is also connected to, and so forth. In one example however, in contrast with determining trusted user accounts, in order to determine fraudulent user accounts, the contagion component can determine which user account(s) has a directed edge pointing to an initially fraudulent user account, in the example of a directed graph. In other words, in such an example, the contagion component can determine users who include fraudulent users (e.g., the initially identified fraudulent users) in their contacts or contact lists as also being fraudulent. The contagion component can perform the contagion operation(s) (e.g., a first-step or multi-step contagion operation), and can indicate or label such identified fraudulent user account(s) accordingly. Similarly, the number of steps or degrees of contagion operations for identifying fraudulent user accounts can be configured by an administrative user of the system 100.

Still further, in some examples, the number of steps or degrees of contagion operations for identifying trusted users and the number of steps or degrees of contagion operations for identifying fraudulent users can be equal or different (e.g., one may be larger than the other). In addition, in variations, the contagion component can perform the contagion operation(s) with a very large number of steps (e.g., ten, thirty, one hundred, etc.) or with no limit to the number of steps (e.g., one hundred, or infinite).

Once the contagion component performs the contagion operation(s) and identifies the user accounts as being trusted or fraudulent (or as being unknown or colluding), the account classify 150 can label, score or weight the user accounts accordingly. For example, in some instances, a user account may be identified as being both trusted and fraudulent (e.g., it may have a one-way connection from a trusted user account and may have a one-way connection to a fraudulent user account). Such a user account can be identified as being colluding, or weighted to be probative for or against a particular determination when the account is being used to determine whether another account or activity is fraudulent. In another case, a user account may not have a connection with trusted user accounts or fraudulent user accounts, or may be a number of degrees away from trusted user accounts or fraudulent user accounts in which the contagion operation(s) does not result in identifying such user account as trusted or fraudulent (e.g., a greater degree away than the specified limit for the contagion operation(s)). Such a user account can be identified as being unknown. In one example, the account classify 150 can associate a label as a result of the contagion operation(s) with each of the respective user accounts in the rider database 141 and/or the driver database 142. According to some examples, the system 100 can perform one or more remedial actions for those user accounts that are labeled as fraudulent.

As an addition or an alternative, after the contagion component performs the contagion operation(s), the score determine component of the account classify 150 (or scoring component, as illustrated in FIG. 1), can further compute the reputation score 155 for each user account of the plurality of user accounts. In one example, the score determine can use the connection data 121 and the identified trusted user accounts and fraudulent user accounts to determine a reputation score for each user account of the plurality of user accounts. The system 100 can use the reputation score 155, for example, to assign a classification or weight (e.g., for use in validation determinations of other user accounts) to individual user accounts. The classification can be a secondary verification or an additional confirmation for the system 100 to confirm the trustworthiness of a user account, as opposed solely relying on the determination of whether the user account is trusted or verified resulting from the contagion operation(s).

According to an example, the reputation score 155 can be represented by a single number, or a set of numbers, such as a pair of numbers (e.g., positive or negative numbers, decimals, fractions, integers, etc.). For a single number, the reputation score 155 can be based on a combination of a weighted value representing a trust score and a weighted value representing a fraud score. For a pair of numbers (e.g., an integer pair), the reputation score can comprise a first value (e.g., a first integer) that represents a trust score and a second value (e.g., a second integer) that represents a fraud score, represented by (X, Y), where X is the trust score and Y is the fraud score. In some examples, the scoring component can compute or calculate the reputation score for each of the user accounts in the plurality of user accounts based on the neighboring user accounts of that user account. In particular, the scoring component can determine, for each user account, the neighboring user account(s) that that user account is connected to (e.g., based on the connection information) and the labels of those neighboring user account(s) (e.g., trusted or fraudulent). In other words, according to one example, the scoring component can determine the reputation scores based on the directed graph in connection with which user accounts have been identified as being trusted and/or fraudulent.

For example, in some implementations in which the reputation score 155 corresponds to a first value and a second value, for a user account, the scoring component can (i) determine the first value based on a number of neighboring user account(s) labeled as being trusted, which have a directed edge or a one-way connection to that user account, and (ii) determine the second value based on a number of neighboring user account(s) labeled as being fraudulent that that user account has a directed edge or a one-way connection to. The reputation scores 155 can be stored or associated with the respective user accounts in the rider database 141 or the driver database 142 (depending on whether a user account corresponds to a rider account or a driver account, respectively).

The scoring component can also use other data or factors to compute the reputation score for individual user accounts. For example, the connection builder 120 (and/or the contact collect 110) may have previously determined time information or a timestamp when a connection between two user accounts were determined or established from the contact information, or an age of the user account itself (e.g., when the user account was created). The time information can be stored with or associated with the connection information. The age or the time when a connection was established between user accounts can be used as a factor in computing the reputation scores. In one example, an older one-way connection pointing from a trusted user account to a user account can be given more weight as compared to a newer or newly established one-way connection from the trusted user account to another user account (e.g., a multiplier less than 1×). As an addition or an alternative, a connection from an older trusted user will be given more weight than a connection from a newer trusted user.

Still further, in another example, the connection builder 120 can determine or store information about the shortest length or degree of path of connection(s) from an initially identified trusted user account or an initially identified fraudulent user account to other user accounts. The scoring component can use the length of connections as a factor in computing a reputation score. For example, a one length connection from an initially trusted user account to a first user account can be given more weight as compared to a two length connection from an initially trusted user account to a second user account. In such examples, the age comparison of connections, the length thresholds, the weights, etc., can be configured by an administrative user of the system 100.

In some implementations, as an addition or an alternative, the account classify 150 can also assign or associate a classification or a tag with a user account based on the reputation score for that user account. The classification can correspond to a trusted classification, a fraudulent classification, a dubious (or colluding) classification, and/or an unknown or unverified classification. For example, the account classify 150 can compare the reputation score for user accounts with a threshold scoring value(s) in order to make a classification. The account classify 150 can use different threshold scoring values for different types of users (e.g., riders versus drivers), for different geographic regions in which users are located, or for different values of reputation scores (e.g., a first threshold value can be used to compare the trust score of a reputation score as compared to a second threshold value that is used to compare the fraud score of the reputation score).

As an example, the account classify 150 can assign a user account, having a trust score (of the reputation score of that user account) that is greater than (or greater than or equal to) a threshold scoring value (e.g., one, three, six, etc.) and having a fraud score of zero, a trusted classification. As another example, the account classify 150 can assign a user account, having a trust score that is greater than a threshold scoring value and having a fraud score that is greater than zero, a colluding classification. Still further, in another example, the account classify 150 can assign the same user account a fraudulent classification, despite having a trust score. In still another example, the account classify 150 can assign a user account, having a trust score less than a first threshold scoring value and having a fraud score less than a second threshold scoring value (or having a trust score and a fraud score of zero), an unknown classification. In such an example, a user associated with such a user account may not have shared their contacts list and/or may not have any contacts (friends or family) that have user accounts with the network service (e.g., may not be a user of the service arrangement system). The account classify 150 can store the classification information for individual user accounts with or in association with the user accounts in the rider database 141 and/or the driver database 142.

The classifications can provide an efficient mechanism for other services, systems, or sub-systems of the system 100 to perform remedial actions with respect to some actions performed by users in connection with certain user accounts. As opposed to individual services or systems having to decipher or process individual reputation scores for user accounts to determine whether a user account is trusted or not, the account classify 150 can provide a uniform classification standard to be used across all services or systems. This can significantly reduce the amount of time and/or power spent performing addition processes by individual services or systems. In some examples, the account classify 150 can further narrow down the classifications to provide even more efficiency (e.g., from four- trusted, fraudulent, colluding, and unknown, to two - trusted or fraudulent, such as by grouping all non-trusted classifications as being fraudulent).

In one example, the classifications of the user accounts can be used by other components of the system 100, such as the service manage 160, to perform one or more actions in connection with the user accounts. Alternatively, in examples, in which no classifications are made based on reputation scores, the service manage 160 can use the reputation scores 155 to perform one or more actions in connection with the user accounts.

In the example of FIG. 1, the service manage 160 can communicate with the rider device interface 174 to exchange data with the rider devices 180 and with the driver device interface 175 to exchange data with the driver devices 190. In one example, the service manage 160 can further implement a validation check using the validation component 170, in response to a predetermined event or condition. For example, the service manage 160 can receive a request 185 for transport from a rider device 180, which includes at least the rider's ID and transport service parameters. Depending on implementation, in a first example, the request 185 can correspond to a predetermined event for which the service manage 160 can make a validation request 163. The validation request 163 can identify the corresponding rider account using the ID (or alternatively, using another ID, such as the rider's token, phone number, device identifier, etc.), and further initiate a process in which the validation component 170 communicates directly or indirectly with the database(s) 140 to obtain rider's classification information 157. The validation component 170 can communicate the classification information 157 to the service manage 160, which can then implement one or more measures or actions depending on the outcome of the determination. For example, if the determination is that the request 185 is generated from (or using a rider device that is associated with) a fraudulent account, the service manage 160 can cancel the request or trigger a communication to the rider device so that the rider device will validate itself. If, on the other hand, the validation determination is that the request 185 originates from a trustworthy account, then no intervening action needs to be performed. In some implementations, the validation component 170 can return a score or value that is reflective of a confidence or reputation of the requesting account. The service manage 160 can implement actions such as account monitoring, based on the score provided by the validation component 170.

For example, if the rider account is classified as a trusted account, the service manage 160 can process the request 185 normally (e.g., in a default manner) and select a driver for the rider to provide the transport service. On the other hand, if the rider account is classified as a fraudulent account, the service manage 160 can deny the request 185 outright or perform another validation or verification process (e.g., communicate with a payment processing system to validate the payment method of that user account, and/or transmit an authentication message to the rider device 180, etc.). Depending on variations, in some examples, the service manage 160 can be configured, if the rider is classified as a colluding user or an unknown user (alternatively, in some examples, such a colluding user or an unknown user can be classified to be a fraudulent user), to deny the request 185 or transmit a notification to the rider device 180 asking the user of the rider device 180 to provide additional information for performing a verification of the rider account. Alternatively, the system 100 can perform the classification checking operation when a user opens or activates a service application 181, 191 on a respective device 180, 190 (e.g., when the service application 181, 191 is opened, a user ID and/or a device ID or a user token can be provided to the system 100 via the respective device interface 174, 175).

In a second example, the service manage 160 can perform the classification checking operation when the service manage 160 selects a driver for the rider. In such an example, the service manage 160 can perform the classification checking operation on both the rider and the selected driver. The service manage 160 can access the respective user accounts for the rider and the driver and determine the classifications for the rider and the driver. The service manage 160 can perform an action based on the determined classifications. For example, if the rider account is classified as a trusted rider account and the driver account is classified as a trusted driver account, the service manage 160 can arrange the service to be provided by the driver for the rider. If the rider account is classified as a trusted rider account and the driver account is classified as a fraudulent or colluding driver account, the service manage 160 can deny the match. Similarly, if the rider account is classified as a fraudulent or colluding rider account and the driver account is classified as a trusted driver account, or if both rider and driver accounts are classified as fraudulent or colluding accounts, the service arrange 160 can deny the match. According to another example, if one or both of the rider or driver account is classified as colluding or unknown, then the service manage 160 can use the fraud scores of those accounts to determine whether to enable the service to be provided or deny the match, e.g., as a fallback. As an addition or an alternative, the service manage 160 can trigger or cause the fraud determine 130 to determine the fraud score for the rider account and/or the driver account.

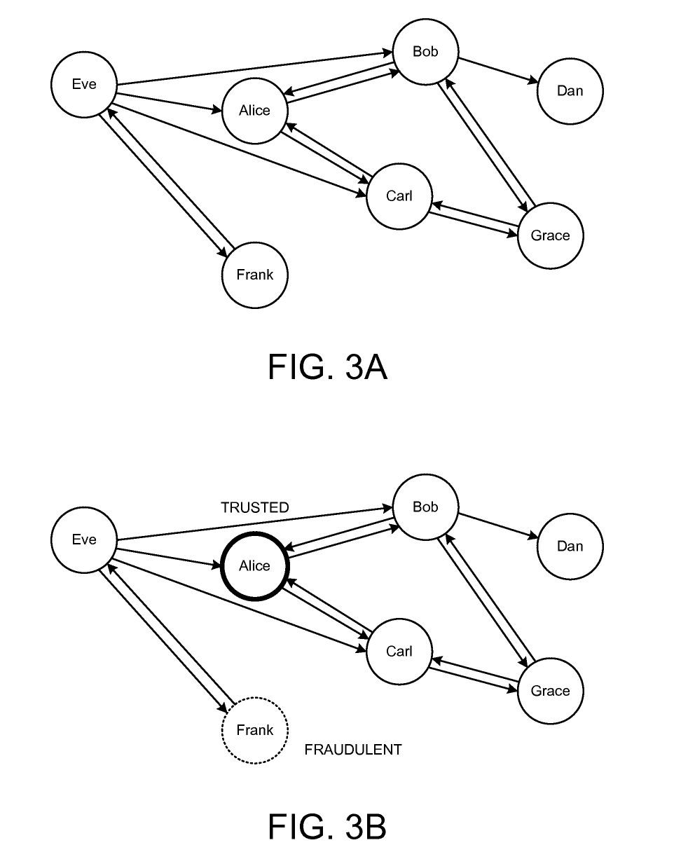

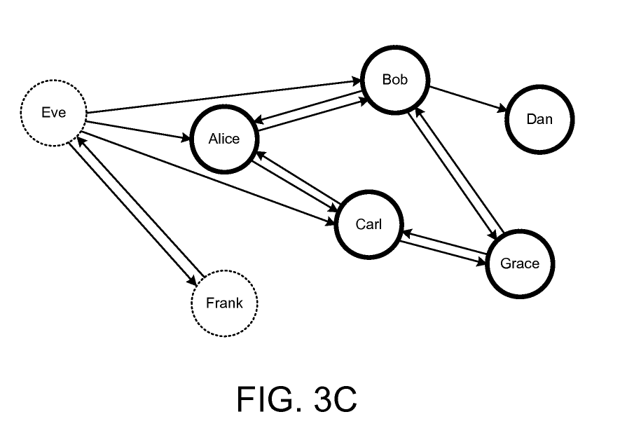

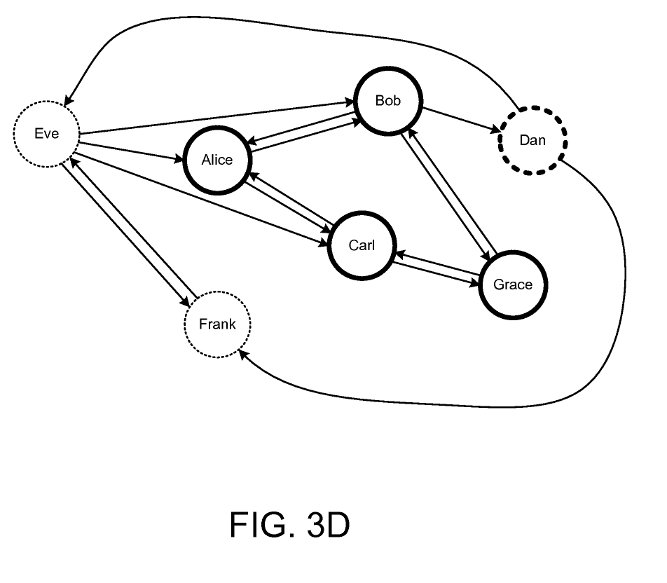

In addition, the system 100 can implement the validation component 170 to make responsive or real-time validation determinations in response to predetermined events that occur with the network service offered through the system 100. The validation component 170 can generate a validation determination in response to events such as (i) new account generation, (ii) occurrence of an event in which a referral fee is generated, and/or (iii) using a new or recently created account to obtain a benefit or service that is not available for others. Still further, the validation component 170 can be responsive to a user input 173 in some implementations, the validation component 170 includes a user interface 175 for receiving input 173, and further for communicating a output 171. The output 171 can correspond to the real-time validation determination of an event (e.g., new account established, referral to new account made, other forms of account activity associated with the recent account), or alternatively to a visualization of information (e.g., social graph, or hashed variant thereof). For example, the output 171 can correspond to the visualization of the social graph, and an administrative user (or other network operator) is may view data representations of user accounts and/or individuals in order to detect (or view detected) user accounts that share social connections. The validation component 170 can provide the output 171 as a presentation and can also receive user input 173 when the user interacts with the presentation. In one variation, the validation component 170 can generate a visualization of a directed graph (or portions of the directed graph) using graph visualization data 123 (and/or provide data along with the nodes of the visualization, such as reputation scores). The graph visualization data 123 can be received from the connection builder 120 (e.g., data corresponding to or based on the connection data 121) and/or database 140. In some implementations, the graph visualization data 123 can also provide a hashed visualization of the social graph. An example of graph visualization data 123 is illustrated by FIG. 3C, which depicts user accounts as nodes and directed edges as single arrow lines. The administrative user can interact with the presentation to view details about a represented user account by selecting the user account, for example, such as to view details about the fraud score, the reputation score, user information, etc.

Still further, while some examples described the sets of contact information 183, 193 (or hashed variants 183h, 193h) as phone numbers (or email addresses, etc.) retrieved or determined from users' contact lists, in variations, the system 100 can receive the hash values of the contact information 183, 193 from the user devices (shown as 183h, 193h). Still further, in other variations, what is communicated is a portion of the information item, rather than the whole information item (e.g., last four digits of a phone number).

In one implementation, each of the rider device interface 174 and the driver device interface 175 have a respective hash generator 189, 199, corresponding to code which is communicated to the respective end user devices 180, 190. Thus, in some implementations, the actual information items (e.g., phone number) from the user's contact records is communicated in hashed form, rather than in human perceptible form. The respective client applications 181, 191 can execute a hashing algorithm based on the code received from the hash generator 189, 199. The hash algorithm that is implemented can be shared amongst devices of a group or population of users, so that the hashed value derived for the same phone number or email address on different devices is the same. In some implementations, the client applications 181, 191 can implement logic to format the underlying information item so that the given information item has a common format and structure prior to hashing.

In one implementation, contact collect 110 receives and stores hash values 183h, 193h (e.g., the digest outputted by the hash algorithms) for a select information item. For example, the client application 181 on the first rider's device 180 can use a secure hash algorithm, stored as part of code of the client application 181, to generate a hash value 183h for each of the phone numbers in the first rider's list of contacts. The client application 181 can then transmit the hash values 183h of the phone numbers to the contact collect 110. The contact collect 110 or connection builder 120 can implement hash value comparison logic to determine when two or more instances of the same hash value 183h, 193h occur (e.g., as cell values in a table), and this determination can then be used to determine respective hashed versions of the connections 119 (shown as connections 119h), social graph 125 (shown as social graph 125h), and/or connection data (shown as 121h). Likewise, the operations performed by the fraud determination component 130, account classify 150 and/or validation component 170 can be based on the respective hash values, so that no human comprehensible information is used with respect to at least some portions of the connections 119, social graph 125 and or connection data 121.

In this way, the system 100 can use the same secure hash algorithm to determine the hash values of the phone numbers associated with or stored with the user accounts, and can use the hash values as opposed to the actual phone numbers, for example, to determine connections between user accounts, such as described with FIG. 1. In such an example, by using hash values of contact information, the system 100 can provide a level of protection for maintaining the secrecy of sensitive information items (e.g., phone numbers of contact records). In variations, different encryption algorithms can be used by the user devices and the system 100 to protect the contact information 183 during transmission and/or during storage by the system 100.

Still further, while examples described with respect to FIG. 1 discuss user accounts of the system 100, in other examples, the system 100 can determine connection information and reputation scores for representations of non-users (or individuals who do not have an account). A determination as to whether such individuals are genuine can be probative as to whether other account holders or service users are engaging in fraudulent activity. The determination of non-account holders can be done through, for example, identifier (ID) files or fragments. In many instances, while a rider (who has a user account with the system 100) can provide a set of contact information of the rider's contacts to the system 100, many of the rider's contacts may not have a user account with the system 100 (e.g., may not be a user of the network service or have signed up to participate to be a driver, etc.). The system 100 can create an ID fragment for the rider's contact even if that contact does not have an associated user account. The operations performed by the system 100, as described with FIG. 1, can be similarly performed in connection with the ID fragment. The ID fragment can be stored in the ID fragment database 145 and can comprise contact information of that contact (e.g., a phone number, an email address, a user name, etc.), an ID fragment identifier, a reputation score, and/or a classification. In some examples, ID fragments can be used for all users and contacts, including those users that already have an account with the system 100 (e.g., those user accounts can be associated with the respective ID fragments).

For illustrative purposes, for example, the connection builder 120 can determine how users and contacts of those users are linked or connected to each other even without some of those contacts having user accounts with the system 100. The connection data 121 can indicate which users and contacts have connections with other users and contacts. The account classify 150 can identify a first subset of users (e.g., identify a first subset of respective ID fragments) as being trusted and a second subset of users (e.g., identify a second subset of respective ID fragments) as being fraudulent. The contagion component can perform one or more contagion operation(s) to subsequently identify (and/or label) other ID fragments as being trusted or fraudulent based, at least in part, on the connection data 121 and the identified first and second subsets of ID fragments. The scoring component can compute the reputation scores for the ID fragments and associate and/or store the reputation scores with the respective ID fragments. In some examples, the account classify 150 can further assign a classification to the ID fragments based on the reputation scores. By using ID fragments, the system 100 can store classification information for the ID fragments, and at a later time, can associate the ID fragments or information from the ID fragments with respective user accounts when they are created at a later time (e.g., when those users sign up with the network service). Still further, using ID fragments can protect the privacy of those individuals who are not a user of the system 100 as only a contact information would be stored (and in some cases, would be stored as a hash value, such as described in one example).

Methodology

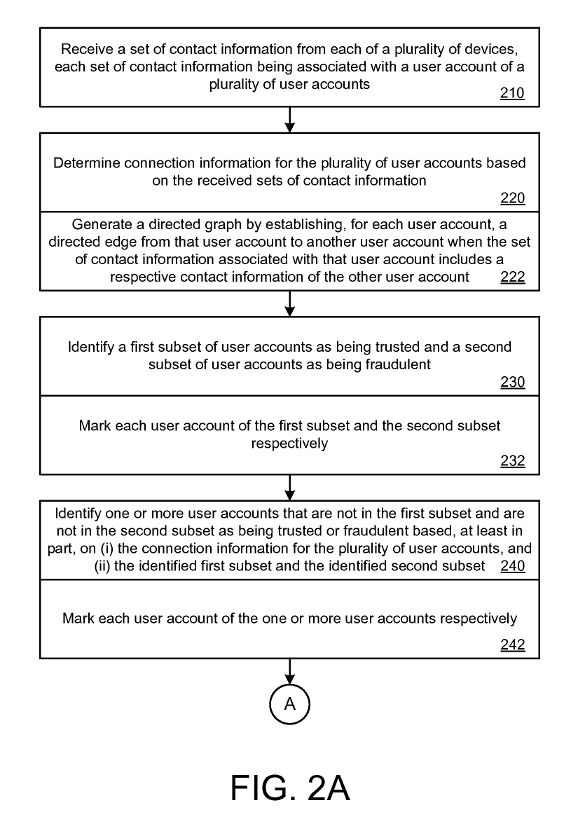

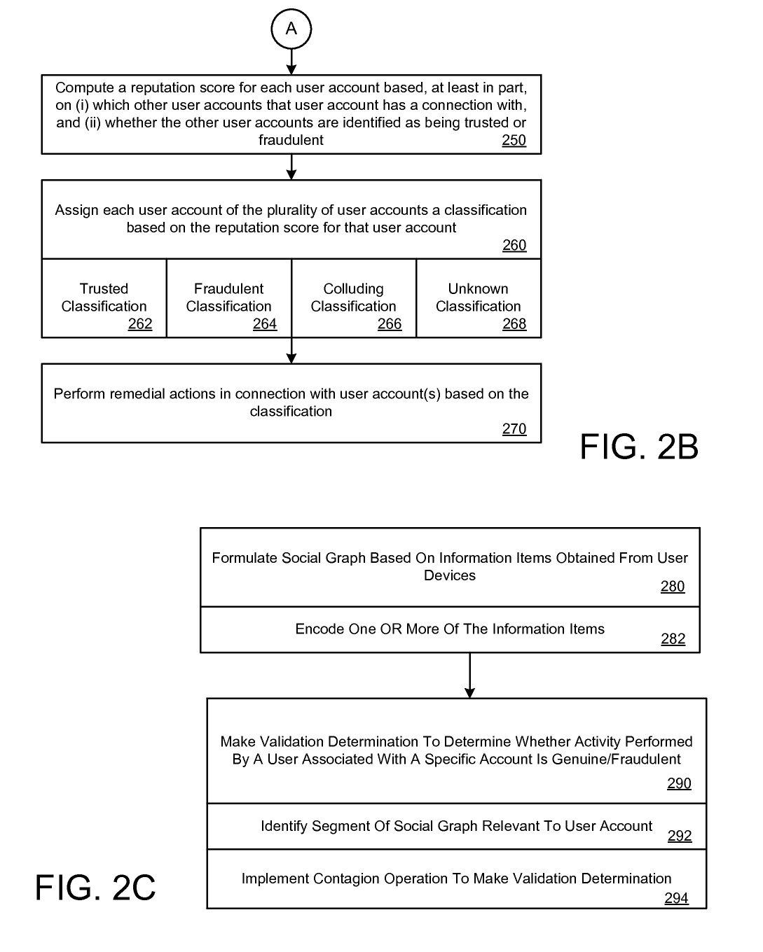

FIGS. 2A through 2C illustrate examples for determining fraudulent user accounts, in some embodiments. Methods such as described by examples of FIGS. 2A through 2C can be implemented using, for example, components described with FIG. 1. Accordingly, references made to elements of FIG. 1 are for purposes of illustrating a suitable element or component for performing a step or sub-step being described.

Referring to FIG. 2A, a service arrangement system, such as the system 100 of FIG. 1, can receive or retrieve a set of contact information from each of a plurality of user devices (210). Each set of contact information can be associated with a user account of a plurality of user accounts that is stored in a memory resource(s) accessible by the system. For example, referring to FIG. 3A for illustrative purposes, a plurality of users (Alice, Bob, Carl, Dan, Eve, Frank, and Grace) that are users of the network service implemented by the system 100 and that have agreed to share their respective contacts with the system 100. Each of the seven users can have a corresponding user account, indicated by a respectively named node as shown in the diagram of FIG. 3A. In some examples, each node can correspond to an ID fragment or file as opposed to a user account. The system 100 receives a first set of information items corresponding to contact identifiers (e.g., phone numbers, email addresses, contact names, etc.) from Alice's collection of contact records, a second set of information items corresponding to contact records information of Bob's collection of contact records, and so forth.

The system 100 determines connection information for the plurality of user accounts based on the received sets of contact information (220). The connection information can indicate which user accounts have connections with other user accounts. For example, the connection builder 120 can establish a one-way connection from a first user account to a second user account if the first user of the first user account had, in the first user's set of contacts, contact information (e.g., email address, phone number or other information item) associated with the second user account, and so forth. The connection data 121 can be stored in a table(s) or list(s) indicating one-way connections (and/or mutual connections if two user accounts have one-way connections with each other). In one example, the system 100 can generate a social graph, shows as a directed graph, by establishing, for each user account, a directed edge pointing from that user account to another user account when the set of contact information associated with that user account includes a respective contact information of the other user account (222). In other words, as illustrated in FIG. 3A, Alice had the contact information for Bob and Carl in Alice's set of contacts, so a directed edge points from Alice to Bob and from Alice to Carl in the directed graph. Similarly, Bob had Alice's contact information but also Dan and Grace's contact information in Bob's set of contacts. Frank only had the contact information of Eve in Frank's set of contacts. For illustrative purposes, the users may have had contact information for other contacts, but are not illustrated in FIGS. 3A through 3D.

The system 100 can identify a first subset of user accounts as being trusted and a second subset of user accounts as being fraudulent (230). For example, a user account can be associated with a fraud score that indicates whether the user account is a trusted user account, a fraudulent user account, or indeterminate user account. As illustrated in FIG. 3B, Alice's user account can be initially determined to be a trusted user account, while Frank's user account can be initially determined to be a fraudulent user account. While step 230 is described after step 220 in the example of FIG. 2, in other examples, the system 100 can perform step 230 before step 220 (or even before step 210) or concurrently with step 220 (or step 210). In one example, the system 100 can also mark or label (e.g., textual label, a number or pair of numbers, a flag, a set of bits, etc.) each user account of the first subset as being trusted and each user account of the second subset as being fraudulent, respectively (232). For illustrative purposes, Alice is shown in FIG. 3B with a label “TRUSTED” and a thick circle boundary and Frank is shown in FIG. 3B with a label “FRAUDULENT” and a dotted circle boundary to represent the label.

The system 100 can perform one or more contagion operations to identify one or more user accounts that is not in the first subset and not in the second subset as being trusted or fraudulent based, at least in part, on the (i) connection information for the plurality of user accounts, and (ii) the identified first subset and the identified second subset (240). The system 100 can also mark or label those user accounts accordingly (242). For example, the system 100 can determine, from the connection information, which user account(s) each initially trusted user account is connected to (e.g., which user account(s) has a directed edge pointing from an initially trusted user account in the example of a directed graph), and which subsequent user account(s) that user account(s) is connected to and so forth. Referring to FIG. 3C, Bob and Carl each have a directed edge pointing from Alice, the initially trusted user account. Accordingly, the system 100 can identify Bob and Carl as being trusted. Because Bob is trusted, Dan is identified as being trusted (e.g., a second length or degree from Alice). Grace is identified as being trusted because Bob is trusted (or additionally or alternatively, because Carl is trusted).

The system 100 can also determine, from the connection information, which user account(s) each initially fraudulent user account is connected to, and which other user account(s) that user account(s) that is subsequently identified as being fraudulent is also connected to, and so forth. The system 100 can determine which user account(s) has a directed edge pointing to an initially fraudulent user account. Referring to FIG. 3C, the system 100 can determine which user accounts have a directed edge pointing to the initially fraudulent user, Frank. In this example, only Eve has a directed edge pointing to Frank (e.g., Eve has Frank's contact in her contacts list).

According to some examples, the system 100 can use these labels to perform remedial actions in connection with fraudulent user accounts, such as when a fraudulent user account is being used to request a service or is being used to provide a service. In some examples, the system 100 can perform additional operations, such as described in FIG. 2B. For example, referring to FIG. 2B, the system 100 can compute a reputation score for each user account based, at least in part, on (i) which other user accounts that user account has a connection with, and (ii) whether the other user accounts are identified as being trusted or fraudulent (250).

In the examples in which a reputation score is represented by a pair of numbers (e.g., a trust value, and a fraud value), the trust value for a user account is based on a number of neighbor user accounts (based on the connection information) that are identified and/or labeled as being trusted who point to that user account, while the fraud value for a user account is based on a number of neighbor user accounts (based on the connection information) that are identified and/or labeled as being fraudulent that the user account points to. Referring to FIG. 3C, Eve has added the contact information of trusted users, but those other users have not added Eve to their contacts. The system 100 can ignore the directed edges from Eve to trusted user accounts. In other words, Alice, Bob, and Carl are not disadvantaged by a fraudulent user's attempt to add them to her contacts.

Referring to FIG. 3C, the system 100 can determine the reputation scores for the user accounts as follows: Alice would have a reputation score of (2, 0), Bob would have a reputation score of (2, 0), Carl would have a reputation score of (2, 0), Dan would have a reputation score of (1, 0), Eve would have a reputation score of (0, 1), Frank would have a reputation score of (0, 1), and Grace would have a reputation score of (2, 0). Based on the reputation scores, the system 100 can further assign each user account a classification (260). Depending on implementation, the classification can correspond to a trusted classification (262), a fraudulent classification (264), a colluding classification (266), and/or an unknown classification (268). The system 100 can determine the classifications using a threshold scoring value(s) and comparing the reputation score to the value(s). For example, the system 100 can determine whether a trust value is greater than a first threshold scoring value and whether a fraud value is greater than second threshold scoring value.

As an example, the system 100 can determine that: (i) if the reputation score is (x, 0) with x being greater than a threshold, t, the user account is assigned a trusted classification, else is assigned an unknown classification, (ii) if the reputation score is (0, y), the user account is assigned a fraudulent classification, (iii) if the reputation score is (0, 0), the user account is assigned an unknown classification, and (iv) if the reputation score is (x, y), the user account is assigned a colluding classification. In such an example, if the threshold value is 1, the system 100 can determine that Alice, Bob, Carl, and Grace are trusted user accounts, while Dan is an unknown user account (e.g., not enough trusted users know Dan), and Eve and Frank are fraudulent user accounts. As another example, if the threshold value is 0 or no threshold value is used, the system 100 can determine that Alice, Bob, Carl, Dan, and Grace are trusted user accounts, while Eve and Frank are fraudulent user accounts, based on the reputation scores. While positive integers are used in this example, one or more of the scores in the reputation score can be decimals, fractions, or negative numbers. The system 100 can use the classification of users to enable or prevent usage of the network service (e.g., perform remedial actions, such as notify users or deny requests, etc., for fraudulent user accounts) (270).

Alternatively, in another example, if a user, Henry, who is a user of the network service elected to not share his contacts or he has no contacts that are also users and/or is not a contact of another user, Henry would be given a score of (0, 0) and classified as being unknown. In another example, if Dan had added Eve and Frank to his contacts, such as illustrated in FIG. 3D, Dan would have additionally been given a reputation score of (1, 2). In such case, Dan would be considered a colluding user and in some examples, can be treated as a fraudulent user by the system 100, such as when Dan makes a request for transport service or tries to go online or on duty to be available to provide transport services (e.g., Dan may be prevented from receiving an invitation to provide a service for a rider).

Still further, while examples for determining connections for users are described using contact information, such as phone numbers or email addresses in a contacts list or connections in friends list on a social network, in another example, a connection between two users can be established using other data. For example, the network service can provide a mechanism to enable a first user to invite a second user to use the network service (e.g., and/or create a user account to have access to the network service) using an invitation code or referral code of the first user. If the second user joins the network service and/or creates a user account using the invitation code or referral code of the first user, a connection can be established between the first and second users (e.g., even if the users do not have each other's contact information in their respective contacts list).

With reference to an example of FIG. 2C, a network system such as provided by the service arrangement system 100, formulates a social graph (or data representation thereof) based on information items obtained from user devices, and/or records or information associated with such user devices (280). Segments of the social graph may be hashed, or otherwise made non-decipherable to humans. For example, information items such as names or communication identifiers can be hashed into alphanumeric values which are not decipherable as either a name or communication identifier, but simply appear as a random string of characters. The segment of the social graph can correspond to select information items from individuals who are represented in the social graph, such as name or communication identifier. For example, the social graph can be constructed based on the first names of persons and the phone numbers or email addresses of all persons in the graph can be hashed and not human-decipherable. The visualization of the social graph may then associate nodes with first names, and fields for phone number or email address can be provided hashed values which are also user-specific. In this way, the information items that form a portion of the social segment can be hashed or otherwise encoded so as to not be human decipherable, precluding mental determination by humans of at least some user-specific values for one or more types of information items (282).

Upon formation of the social graph for a relevant set of users, a validation determination can be made to determine whether the activity performed by a user associated with a specific user account is genuine, or not fraudulent (e.g., activity is not premised or made through a fraudulent account made in violation of rules of the arrangement service) (290). In making the determination, the arrangement service 100 can identify a portion of the social graph which relates to the specific user account (e.g., pertains to life characteristics of the user of the specific user account) (292). The portion of the social graph can correspond to individuals who are relevant to the user, such as those persons who are represented in the contact records of the user, or who may otherwise have sufficient social proximity to serve as a source for the validation determination.

The arrangement system 100 can implement a contagion operation on at least the identified portion of the social graph in order to make the validation determination for the user account or activity (294). The validation determination can be based on whether the social graph identifies any or multiple (e.g., beyond a threshold number) or fraudulent accounts or activities which are sufficiently connected to the user (e.g., within one or two or three degrees of separation, depending on desired configuration rules) to weigh in favor or against the validation determination. Thus, for example, a scoring methodology (e.g., for determining reputation scores) can be made which weights instances of determined fraudulent activity based on factors such as the degree of separation between the specific user account and a user for which fraudulent activity is suspected or determined as having existed.

Hardware Diagrams

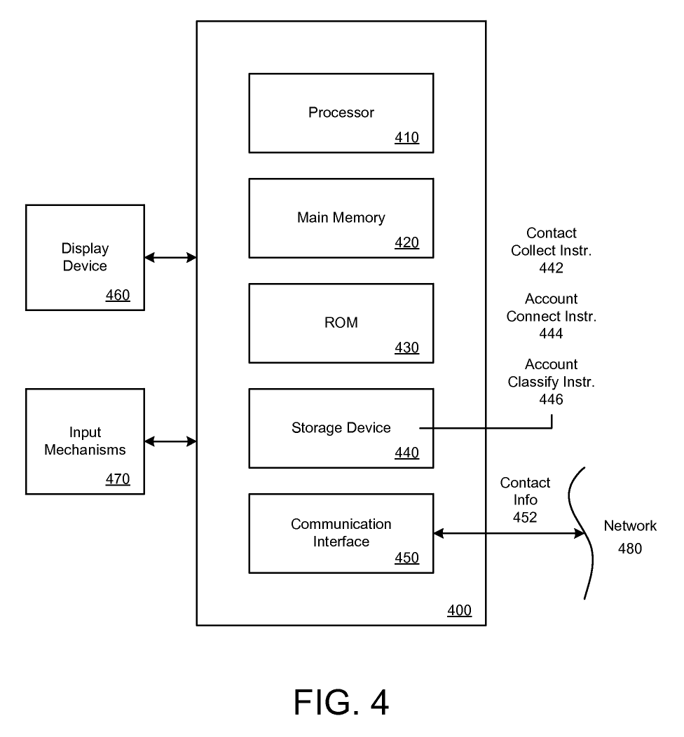

FIG. 4 is a block diagram that illustrates a computer system upon which embodiments described herein may be implemented. For example, in the context of FIG. 1, the system 100 may be implemented using a computer system such as described by FIG. 4. The system 100 may also be implemented using a combination of multiple computer systems as described by FIG. 4.

In one implementation, a computer system 400 includes processing resources 410, a main memory 420, a read only memory (ROM) 430, a storage device 440, and a communication interface 450. The computer system 400 includes at least one processor 410 for processing information and the main memory 420, such as a random access memory (RAM) or other dynamic storage device, for storing information and instructions to be executed by the processor 410. The main memory 420 also may be used for storing temporary variables or other intermediate information during execution of instructions to be executed by the processor 410. The computer system 400 may also include the ROM 430 or other static storage device for storing static information and instructions for the processor 410. A storage device 440, such as a magnetic disk or optical disk, is provided for storing information and instructions, including contact collect instructions 442, account connect instructions 444, and account classify instructions 446.

For example, the processor 410 can execute the contact collect instructions 442 to implement logic for receiving sets of contact information from a plurality of user devices and/or for associating the sets of contact information with the respective user accounts, such as described in FIGS. 1 through 3C. Such user accounts can be stored in the storage device 440 and/or in other storage devices accessible by the computer system 400. The processor 410 can also execute the account connect instructions 444 to implement logic for determining which user accounts have a connection with other user accounts, such as described in FIGS. 1 through 3D. Still further, the processor 410 can execute the account classify instructions 446 to implement logic for performing a contagion operation(s), for computing reputation scores for the user accounts, and for classifying the user accounts, such as described in FIGS. 1 through 3D.

The communication interface 450 can enable the computer system 400 to communicate with one or more networks 480 (e.g., cellular network) through use of the network link (wireless or wireline). Using the network link, the computer system 400 can communicate with one or more other computing devices and/or one or more other servers or datacenters. In some variations, the computer system 400 can receive sets of contact information 452 from user devices via the network link.

The computer system 400 can also include a display device 460, such as a cathode ray tube (CRT), an LCD monitor, or a television set, for example, for displaying graphics and information to a user. One or more input mechanisms 470, such as a keyboard that includes alphanumeric keys and other keys, can be coupled to the computer system 400 for communicating information and command selections to the processor 410. Other non-limiting, illustrative examples of input mechanisms 470 include a mouse, a trackball, touch-sensitive screen, or cursor direction keys for communicating direction information and command selections to the processor 410 and for controlling cursor movement on the display 560.

Examples described herein are related to the use of the computer system 400 for implementing the techniques described herein. According to one embodiment, those techniques are performed by the computer system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

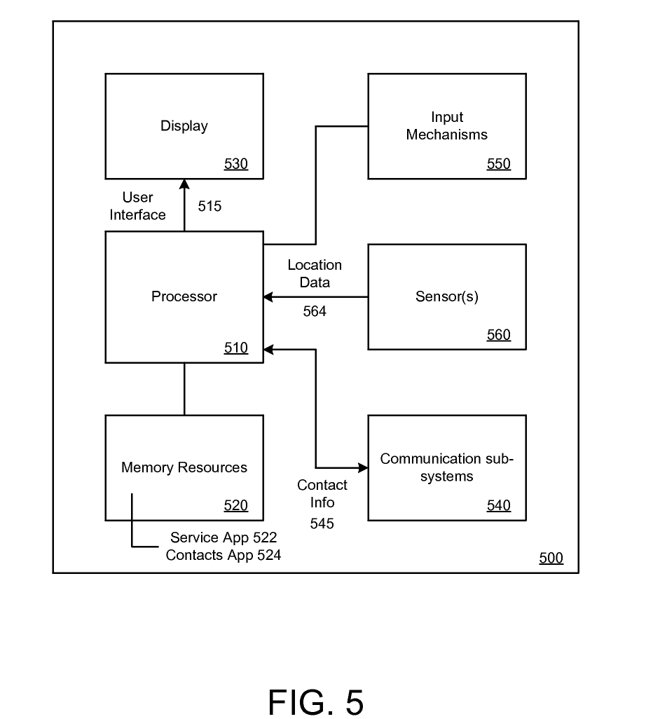

FIG. 5 is a block diagram that illustrates a mobile computing device upon which embodiments described herein may be implemented. In one embodiment, a computing device 500 may correspond to a mobile computing device, such as a cellular device that is capable of telephony, messaging, and data services. The computing device 500 can correspond to a client device or a driver device. Examples of such devices include smartphones, handsets or tablet devices for cellular carriers. The computing device 500 includes a processor 510, memory resources 520, a display device 530 (e.g., such as a touch-sensitive display device), one or more communication sub-systems 540 (including wireless communication sub-systems), input mechanisms 550 (e.g., an input mechanism can include or be part of the touch-sensitive display device), and one or more sensors (e.g., a GPS component, an accelerometer, one or more cameras, etc.) 560. In one example, at least one of the communication sub-systems 540 sends and receives cellular data over data channels and voice channels.

The processor 510 can provide a variety of content to the display 530 by executing instructions and/or applications that are stored in the memory resources 520. For example, the processor 510 is configured with software and/or other logic to perform one or more processes, steps, and other functions described with implementations, such as described by FIGS. 1 through 4, and elsewhere in the application. In particular, the processor 510 can execute instructions and data stored in the memory resources 520 in order to operate a service application 522, such as a client application or a driver application, as described in FIGS. 1 through 4. Data corresponding to the service application 522 as well as data corresponding to the contacts application 524, as described in FIGS. 1 through 4, can be stored in the memory resources 520. Still further, the processor 510 can cause one or more user interfaces 515 to be displayed on the display 530, such as one or more user interfaces provided by the service application 522.

A user can operate the computing device 500 to operate the service application 522. In one example, the computing device 500 can determine a location data point 565 of the current location from the GPS component, which can be used by the service application 522 for providing relevant location-based information on the user interface 515. For example, a user can operate the service application 522 to make a request for an on-demand service. The service arrangement system can receive the request and determine whether the user's user account is a fraudulent user account. As discussed with respect to FIGS. 1 through 4, the service arrangement system can identify one or more user accounts as being fraudulent based on reputation scores that are determined using contact information connections between user accounts. In one example, the service arrangement system can process the request for the user if the user's account is determined to be not fraudulent. On the other hand, if the service arrangement system determines that the user account is marked as a fraudulent user account, it can perform one or more remedial actions, such as rejecting the request. While FIG. 5 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A non-transitory computer-readable medium that stores instructions, which when executed by one or more processors, cause the one or more processors to perform operations that include:
formulating a data representation of a social graph based on information items from a plurality of sources, including from computing devices of individual users in connection with a service provided by a network system, wherein the data representation includes at least a segment that is not human-decipherable, so as to preclude mental determination by humans of at least some user-specific values for one or more types of information items; and
making a validation determination for an activity performed by a user associated with a specific user account by (i) identifying a portion of the social graph as relating to the specific user account, and (ii) implementing a contagion operation on at least the identified portion of the social graph.

2. The non-transitory computer-readable medium of claim 1, wherein the instructions, which when executed by the one or more processors, cause the one or more processors perform operations that further include:
providing instructions to computational resources of individual users of a given group or population of users, in order to generate, for each individual user, a set of encoded information items that are not human-decipherable, without a corresponding information item of the set being communicated to computational resources which are outside of the individual user's control.

3. The non-transitory computer-readable medium of claim 1, wherein the information items include phone numbers.

4. The non-transitory computer-readable medium of claim 1, wherein the plurality of sources include mobile computing devices which are associated with the phone numbers.

5. The non-transitory computer-readable medium of claim 1, wherein the validation determination corresponds to a reputation score.

6. A computer system comprising:
a memory that stores instructions; and
one or more processors that execute instructions stored in the memory to:
formulate a data representation of a social graph based on information items from a plurality of sources, including from computing devices of individual users in connection with a service provided by a network system, wherein the data representation includes at least a segment that is not human-decipherable, so as to preclude mental determination by humans of at least some user-specific values for one or more types of information items; and
make a validation determination for an activity performed by a user associated with a specific user account by (i) identifying a portion of the social graph as relating to the specific user account, and (ii) implementing a contagion operation on at least the identified portion of the social graph.

7. A non-transitory computer-readable medium that stores instructions, which when executed by one or more processors of a computing system, cause the computing system to perform operations that include:
receiving, over one or more networks, a set of contact information from each of a plurality of devices, each set of contact information being associated with a user account of a plurality of user accounts that are stored in one or more memory resources of the computing system;
determining, by the computing system, connection information for the plurality of user accounts based on the received sets of contact information, the connection information indicating which user accounts have connections with other user accounts;
identifying, by the computing system, (i) a first subset of the plurality of user accounts as being trusted, and (ii) a second subset of the plurality of user accounts as being fraudulent; and
subsequently, identifying one or more user accounts that are not in the first subset and not in the second subset as being trusted or fraudulent based, at least in part, on (i) the connection information for the plurality of user accounts, and (ii) the identified first subset and the identified second subset.

8. The non-transitory computer-readable medium of claim 7, wherein the instructions cause the computing system to determine connection information for the plurality of user accounts by:
generating a directed graph by establishing, for each user account, a directed edge from that user account to another user account when the set of contact information associated with that user account includes a respective contact information of the other user account.

9. The non-transitory computer-readable medium of claim 8, wherein the instructions, which when executed by the one or more processors, cause the computing system to perform operations that further include:
generating, for display on a computing device that is in communication with the computing system, a presentation that includes graphical content representing the directed graph.

10. The non-transitory computer-readable medium of claim 7, wherein the instructions, which when executed by the one or more processors, cause the computing system to perform operations that further include:
computing a reputation score for each user account based, at least in part, on (i) which other user accounts that user account has a connection with, and (ii) whether the other user accounts are identified as being trusted or fraudulent.

11. The non-transitory computer-readable medium of claim 10, wherein the reputation score for each user account is further based on a number of connection steps away that user account is from a user account in the first subset or a number of connection steps away that user account is from a user account in the second subset.

12. The non-transitory computer-readable medium of claim 10, wherein the reputation score for each user account is further based on (i) a time when that user account is determined to have a connection with other user accounts, or (ii) a respective time when the other user accounts were individually created.

13. The non-transitory computer-readable medium of claim 10, wherein the reputation score corresponds to a set of values, the set of values including a first value corresponding to a trust score and a second value corresponding to a fraud score.

14. The non-transitory computer-readable medium of claim 13, wherein the instructions, which when executed by the one or more processors, cause the computing system to perform operations that further include:
assigning each user account of the plurality of user account a classification based on the reputation score for that user account.

15. The non-transitory computer-readable medium of claim 14, wherein the classification corresponds to one of (i) a trusted classification, (ii) a fraudulent classification, (iii) a colluding classification, or (iv) an unknown classification.

16. The non-transitory computer-readable medium of claim 15, wherein a user account is assigned the trusted classification when the first value of the reputation score of the user account is greater than or equal to a first threshold value and when the second value of the reputation score of the user account is zero.

17. The non-transitory computer-readable medium of claim 16, wherein a user account is assigned the fraudulent classification when the second value of the reputation score of the user account is greater than or equal to a second threshold value and when the first value of the reputation score of the user account is zero.

18. The non-transitory computer-readable medium of claim 17, wherein the first threshold value is greater than the second threshold value.

19. The non-transitory computer-readable medium of claim 17, wherein a user account is assigned the colluding classification when the first value and the second value of the reputation score of the user account is greater than zero.

20. The non-transitory computer-readable medium of claim 19, wherein a user account is assigned the unknown classification when the first value and the second value of the reputation score of the user account is zero.

21. The non-transitory computer-readable medium of claim 14, wherein the instructions, which when executed by the one or more processors, cause the computing system to perform operations that further include:
receiving, from a first mobile computing device associated with a first user account, a request for a service;
making a determination that the first user account has been assigned the fraudulent classification; and
rejecting the request for the service based on the determination.

22. The non-transitory computer-readable medium of claim 15, wherein the instructions, which when executed by the one or more processors, cause the computing system to perform operations that further include:
receiving, from a first mobile computing device associated with a first user account, data indicating that a service application associated with the network service is operating in a particular state, the first user account being associated with a service provider;
making a determination that the first user account has been assigned the fraudulent classification; and
based on the determination, preventing the first user account from being selected by the network service to provide a requested service for a requester.

23. The non-transitory computer-readable medium of claim 6, wherein each of the plurality of devices corresponds to a mobile computing device associated with a respective user account, and wherein each contact information of the sets of contact information corresponds to a phone number associated with a mobile computing device.

24. A computer system comprising:
a memory that stores instructions; and
one or more processors that execute instructions stored in the memory to:
receive, over one or more networks, a set of contact information from each of a plurality of devices, each set of contact information being associated with a user account of a plurality of user accounts that are stored in one or more memory resources of the computing system;
determine connection information for the plurality of user accounts based on the received sets of contact information, the connection information indicating which user accounts have connections with other user accounts;
identify (i) a first subset of the plurality of user accounts as being trusted, and (ii) a second subset of the plurality of user accounts as being fraudulent;
subsequently, identify one or more user accounts that are not in the first subset and not in the second subset as being trusted or fraudulent based, at least in part, on (i) the connection information for the plurality of user accounts, and (ii) the identified first subset and the identified second subset;
compute a reputation score for each user account based, at least in part, on (i) which other user accounts that user account has a connection with, and (ii) whether the other user accounts are identified as being trusted or fraudulent; and
assign each user account of the plurality of user account a classification based on the reputation score for that user account.

25. A method for providing a network service, the method being implemented by one or more processors and comprising:
receiving, over one or more networks, a set of contact information from each of a plurality of devices, each set of contact information being associated with a user account of a plurality of user accounts that are stored in one or more memory resources of the computing system;
determining, by the computing system, connection information for the plurality of user accounts based on the received sets of contact information, the connection information indicating which user accounts have connections with other user accounts;
identifying, by the computing system, (i) a first subset of the plurality of user accounts as being trusted, and (ii) a second subset of the plurality of user accounts as being fraudulent;
subsequently, identifying one or more user accounts that are not in the first subset and not in the second subset as being trusted or fraudulent based, at least in part, on (i) the connection information for the plurality of user accounts, and (ii) the identified first subset and the identified second subset;
computing a reputation score for each user account based, at least in part, on (i) which other user accounts that user account has a connection with, and (ii) whether the other user accounts are identified as being trusted or fraudulent; and
assigning each user account of the plurality of user account a classification based on the reputation score for that user account.

26. The method of claim 25, wherein the classification corresponds to one of (i) a trusted classification, (ii) a fraudulent classification, (iii) a colluding classification, or (iv) an unknown classification.

27. The method of claim 25, further comprising:
receiving, from a first mobile computing device associated with a first user account, a request for a service;
making a determination that the first user account has been assigned the fraudulent classification; and
rejecting the request for the service based on the determination.
